(19) United States
(12) Patent Application Publication
(10) Pub. No.: US 2002/0071926 A1
(43) Pub. Date: Jun. 13, 2002

(54) The visible note(memo) pad

(76) Inventor: Inseok Yuh, Charlotte, NC (US)

Correspondence Address: Inseok Yuh, 1815 Whispering Forest #202, Charlotte, NC, 28270, US

(21) Appl. No.: 09/848,693

(22) Filed: May 4, 2001

Related U.S. Application Data
(60) Provisional application No. 60/201,361, filed on May 2, 2000.

(51) Int. Cl. B32B 7/06

(52) U.S. Cl. 428/40.1; 428/195; 428/203

(57) ABSTRACT

The disclosed is new self-stick, removable notes (memo pads). Unlike conventional notes (“post-It”, “Highland notes” from 3M company), this new notes is made from semi or transparent materials (enough transparent to read bottom's contents) with white, soft, dark colors and picture and draws on it. This invention enables to read the background content of the document that is normally covered by an attached pad without lifting and detaching the newly added pads. The invention does not have placement restriction that normally blocks the content of background documents when putting the note. These benefits of the invention make it more efficient and enlarge the usage of conventional notes and can be used as the idea improvement tool than just current collecting.

Also in preferred embodiment, the memo pad will be made from various kind semi-transparent, full-transparent materials with various colors and appearances and shapes with picture and draws for the special purpose.

### BACKGROUND OF THE INVENTION

The present invention relates to the improvement of the self-stick, removable notes (memo pad), particularly to the improvement of the material and enlargement of the usage. In eventually, this invention is not just improvement but creating the new concept of note pad in usage area and enlarge the usage of note pad to make it efficient and versatility.

In the view of current note pad, when attaching a notes (memo) to the papers, the content of paper is covered by the conventional memos and cannot read that. If you want to read the content of the background document that is covered by note, you should lift up the pad to read. But you still cannot read the adhesive part, before fully detaching the memos from the document.

To see the background content of the paper that has conventional notes on it or to compare the added memos and the background contents, you should lift and detach from the paper and put back after reading.

In the placement of the notes, if the paper has enough free space to fit the size of pad, it shall be some easy to find the place to put the new memo. But when the paper does not have extra space or has not enough space to fit, most people are embarrassed to find the proper place where the new note-pad should go without blocking up the background content. This invention gives free in placement (location) restriction, since this transparent memo still shows the full background documents wherever the new notes put on.

In the view of new usage field, If this invention is used with another paper that has pictures, draws, letters, this can be used as the guiding tool and education material, discussion tools by showing the background (original) guiding materials.

In the conventional note-pad, when we want to change the memo on the pad, we usually add the new memos just onto the old-memos by stacking the new one or replace that. This blocks and covers the previous one from seeing or destroys the old memo. But, by using this invention, we can just stacked up the new memo-pad with keeping the visualization of old-memo and keep reading and finding the old memo with ease by just looking the background contents instead of removing or lifting of old notes.

The conventional note pad has contributed in collecting the memo and idea clips. This invention will make the contribution in improvement of collected idea and memo. This is possible by using the semi-transparent or full transparent memos or notes which can keep the readability of the background (original) content.

When we write a note on the memo pad for the document, we draw the arrow and line to point the exact place (word, sentence, draws, pictures) to talk. But by using, this invention we don't need to draw the arrow and lines to point, because we can put the note just over the place we want to talk. We can see the place where we want to discuss and write the memos and draw on new-notes which is placed directly on the spot.

The present invention relates to the improvement of the notes and memo pads, particularly to the improvement of the material and enlargement of the usage. In eventually, this invention enlarges the usage of note pad to make it efficient, versatility and creates the new concept of notes in usage area.

### SUMMARY OF INVENTION

This invention is related to the new and unique self-stick, removable notes (memo pads) that can see the background (behind) content of documents (another notes) by using the semi-transparent or full transparent material (paper, plastic, etc) that is transparent enough to see the back.

This note also has various colors to distinguish from the original document and distinguish a note between them, so each note could be easily found and identified by time, subject, person, etc.

Normally the memos can be made from various colored semi-transparent or full transparent material (plastic, paper, etc.,). The new invention may have pictures and letters or draws.

### BRIEF DESCRIPTION OF THE DRAWING FIGURES

This application does not have a drawing.

### DETAILED DESCRIPTION OF THE PREFERRED EMBODIMENT

As described above, the present invention comprises the semi-transparent or full transparent self-stick, removable notes (memo pad) which is transparent enough that can see the background content.

The typical pad sizes which are contemplated by this invention include the 1.5″.times.2″ sheets, the 3″.times.3″ sheets; the 3″.times.5″ sheets, and letter size, legal size and, A3, A4, A1, A2 and even full larger sizes and even smaller sizes.

The visual notes (memos) may have the different color, dark and soft color and different appearance and different shapes.

The colors of each note shall help identify the each memo and know the change history of memos and change of ideas.

In application, the new invention has pictures and letter and draws (drawing guide, scale, study tools, thinking guide) on it, so the notes can be used as special purpose that give special guide and teaching.

It will be obvious that various changes and modifications may be made therein without departing from the spirit and scope of the invention as defined in the described above.

1. What I claim as my invention is the self-stick, removable visual notes (memo pad) is the semi-transparent or full transparent notes that is transparent enough that can see the background (behind) content and can be made from paper, plastic, others.

2. The notes as set forth in claim 1, wherein the size of notes can be the 1.5″.Times.2″ sheets, the 3″.times.3″ sheets; the 3″.times.5″ sheets, and letter size, legal size and, A3, A4, A1, A2 and even full larger sizes and even smaller sizes needed.

3. The notes as set forth in claim 1, wherein the notes shall have various colors and appearances and shapes.

4. The notes as set forth in claim 1, wherein the single pack of notes may have various colors for each other. This helps to distinguish the each memo.

5. The notes as set forth in claim 1, wherein the invention has pictures and characters (alphabetic, number, sign) and draws (drawing pattern, guiding, scale, study assisting tools) on it. By doing this, the pad can be used as special purpose that gives a guide.

7. The notes as set forth in claim 1, wherein it will be obvious that various changes and modifications may be made therein without departing from the spirit and scope of the invention as defined in the described above.
